(19) United States
(12) Patent Application Publication
(10) Pub. No.: US 2009/0098395 A1
(43) Pub. Date: Apr. 16, 2009

(54) Barrier coating for thermoplastic films

(76) Inventor: Pang Chia Lu, Pittsford, NY (US)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 11/872,526

(22) Filed: Oct. 15, 2007

(51) Int. Cl. B32B 27/34; B05D 5/00; B32B 9/04; C08K 3/32; C08K 3/34; C08K 3/36; C08L 91/06

(52) U.S. Cl. 428/454; 427/256; 427/407.1; 524/275; 524/277; 524/414; 524/436; 524/445; 524/447

(57) ABSTRACT

The present invention generally relates to a barrier coating composition for application to a thermoplastic film comprising (a) a nano-clay additive in an amount from about 1 wt % to 50 wt % of said barrier coating, wherein said nano-clay additive comprises untreated nano-clay platelets; and (b) a base coating in an amount from about 50 wt % to 99 wt % of said barrier coating, wherein said base coating comprises a polymer selected from the group consisting of polyvinylidene chloride (PVdC), poly(vinyl)alcohol (PVOH), ethylene vinyl alcohol (EVOH), acrylate copolymers and mixtures thereof.

### FIELD OF THE INVENTION

The present invention relates generally to barrier coatings for use on thermoplastic films. More specifically, this invention relates to coatings with improved barrier properties.

### BACKGROUND OF THE INVENTION

Since the late 1980s a great deal of research around the world has focused on developing methods to incorporate fully exfoliated smectite clays into polymers to increase mechanical and barrier properties of the polymers. Untreated (nonexfoliated) smectite clays have not been suitable for use with polymers because of their incompatibility with hydrophobic materials. One method used to make smectite clays compatible is based organoclay technology developed by John W. Jordan in the 1950s, wherein the clay surface is treated with a surfactant to render it compatible with hydrophobic materials like polyolefins and waxes. This surface-treated clay comprises an adsorbed monolayer of a high-molecular-weight quaternary amine, such as dimethyl dihydrogenated tallow amine. The surfactant adsorption takes place via an ion-exchange reaction involving the negatively charged basal surface of the clay platelets.

The simple mechanism by which the organoclays may improve barrier properties of a coating relies on the high aspect ratio of the exfoliated clay platelets (nano-clay particles). In the coating, the platelets have been observed to assume a generally random orientation or partially aligned in the coating direction; however, there is sufficient overlap of these platelets to create a tortuous path that retards the transport of diffusing species like oxygen or water vapor.

In the packaging of certain types of foods including potato chips, snack foods, and the like, there is a high demand for packaging materials with high gas and water vapor barrier characteristics and high durability. Coated polymeric films are commonly employed in such packaging applications due to their superior physical properties such as stiffness, moisture barrier characteristics and others. Despite these highly desirable properties, many coatings currently known in the art do not provide sufficient gas barrier properties needed for many applications, particularly in food packaging.

U.S. Pat. No. 2,531,427 to Hauser, and U.S. Pat. No. 2,531,440 to Jordan (assignee National Lead Company), both disclose a process to prepare organically substituted clay materials, such as smectite clay mined as bentonite, wherein the exchangeable inorganic cation of the unmodified clay has been substituted with another base to make the surface of the clay particle organophilic.

U.S. Pat. No. 5,334,241 to Jordan (assignee T.O.W. Inc.) discloses an organically modified clay manufactured by a process wherein a clay having an exchangeable, cationic species therein is combined with a cationic organic material and optionally a dispersing agent, subjected to a high confining pressure and mixed while under pressure so as to promote an ion exchange reaction whereby the cationic species is incorporated into the clay.

U.S. Pat. No. 7,078,453 to Feeney, et al. (assigned to InMat Inc.) discloses a barrier coating mixture including (a) a non-butyl elastomeric polymer; (b) an acid or base treated dispersed, substantially exfoliated silicate filler material that has not been functionalized with organic cations having an aspect ratio greater than 25; and (c) at least one additive, wherein the total solids content is less than 30% and the amount of filler is between 5% and about 60% of the total solids content.

U.S. Pat. No. 7,119,138 to Feeney, et al. (assigned to InMat Inc.) discloses barrier coating mixtures including (a) a mixture of pre-vulcanized and non-vulcanized elastomeric polymers; (b) an acid or base treated dispersed, substantially exfoliated silicate filler material that has not been functionalized with organic cations having an aspect ratio greater than 25; and (c) at least one additive, wherein the total solids content is less than 30% and the amount of filler is between 5% to about 60% of the total solids content.

U.S. Pat. No. 7,138,452 to Kim et al. (assignee L.G. Chem, Ltd.) discloses a nanocomposite blend composition comprising a polyolefin resin; one or more nanocomposites having barrier properties, selected from an ethylene-vinyl alcohol (EVOH)/intercalated clay nanocomposite, a polyamide/intercalated clay nanocomposite, an ionomer/intercalated clay nanocomposite, and a polyvinyl alcohol (PVOH)/intercalated clay nanocomposite; and a compatibilizer.

U.S. Pat. No. 6,403,231 to Mueller et al. (assignee Pechiney Emballage Flexible Europe) discloses thermoplastic film structures that incorporate a polymeric nanocomposite comprising a polymer and nanosize particles of a clay that have been modified by an intercalation process so that the clay may be dispersed in the polymer.

None of the above patent references disclose a barrier coating composition which comprises a nano-clay additive and a base coating in which the nano-clay additive comprises untreated nano-clay platelets.

Therefore, a need exists for such a barrier coating that improves the barrier properties of thermoplastic films used in packaging applications (e.g. oxygen or water vapor transmission rates), while maintaining acceptable optical properties, such as haze and gloss, for such films. The present invention meets this and other needs.

### SUMMARY OF THE INVENTION

The present invention generally relates to a barrier coating composition for application to a thermoplastic film comprising (a) a nano-clay additive in an amount from about 1 wt % to 50 wt % of said barrier coating, wherein said nano-clay additive comprises untreated nano-clay platelets; and (b) a base coating in an amount from about 50 wt % to 99 wt % of said barrier coating, wherein said base coating comprises a polymer selected from the group consisting of polyvinylidene chloride (PVdC), poly(vinyl)alcohol (PVOH), ethylene vinyl alcohol (EVOH), acrylate copolymers and mixtures thereof.

In some embodiments, the nano-clay platelets are selected from the group consisting of hectorite, bentonite, vermiculite, montmorillonite, nontronite, beidellite, volkonskoite, saponite, laponite, sauconite, magaditte, kenyaite, ledikite or mixtures thereof.

The nano-clay platelets are present in the nano-clay additive in the amount of less than or equal to about 10 phr; preferably, less than or equal to about 8 phr; more preferably, less than or equal to about 5 phr.

In some embodiments, the nano-clay additive further comprises at least one carrier fluid. The at least one carrier fluid is a polar solvent selected from the group consisting of water, methanol, ethanol, isopropyl alcohol, methyl ethyl ketone, acetone, tetrahydrofuran, methyl acetate, ethyl acetate and mixtures thereof.

In another embodiment, the invention generally relates to a barrier film comprising:

(a) a substrate layer having a first surface and a second surface; and
(b) a barrier coating layer on at least one of said first surface and said second surface, said barrier coating layer comprising:
(i) a nano-clay additive in an amount from about 1 wt % to 50 wt % of said barrier coating, wherein the nano-clay additive comprises untreated nano-clay platelets; and
(ii) a base coating present in an amount from about 50 wt % to 99 wt % of said barrier coating, wherein said base coating comprises a polymer selected from the group consisting of polyvinylidene chloride (PVdC), poly(vinyl)alcohol (PVOH), ethylene vinyl alcohol (EVOH), acrylate copolymers and mixtures thereof.

In still another embodiment, the invention generally relates to a method of coating a film substrate, comprising the steps of:

(a) forming a substrate having a first surface and a second surface; and
(b) applying a barrier coating to at least one of said first surface and said second surface, said barrier coating comprising:
(i) a nano-clay additive in an amount from about 1 wt % to 50 wt % of said barrier coating, wherein said nano-clay additive comprises untreated nano-clay platelets; and
(ii) a base coating in an amount from about 50 wt % to 99 wt % of said barrier coating, wherein said base coating comprises a polymer selected from the group consisting of polyvinylidene chloride (PVdC), poly(vinyl)alcohol (PVOH), ethylene vinyl alcohol (EVOH), acrylate copolymers and mixtures thereof.

In still yet another embodiment, the invention generally relates to a package comprising a barrier film, wherein the barrier film comprises:

(a) a substrate layer having a first surface and a second surface; and
(b) a barrier coating layer on at least one of said first surface and said second surface, said barrier coating layer comprising:
(i) a nano-clay additive in an amount from about 1 wt % to 50 wt % of said barrier coating, wherein said nano-clay additive comprises untreated nano-clay platelets; and
(ii) a base coating in an amount from about 50 wt % to 99 wt % of said barrier coating, wherein said base coating comprises a polymer selected from the group consisting of polyvinylidene chloride (PVdC), poly(vinyl)alcohol (PVOH), ethylene vinyl alcohol (EVOH), acrylate copolymers and mixtures thereof,
   said barrier film being formed into a package adapted to contain a product

### DETAILED DESCRIPTION OF THE INVENTION

Various specific embodiments, versions and examples of the invention will now be described, including definitions that are adopted herein for purposes of understanding the claimed invention. While the following detailed description gives specific preferred embodiments, those skilled in the art will appreciate that these embodiments are exemplary only, and that the invention can be practiced in other ways. For purposes of determining infringement, the scope of the invention will refer to the appended claims and elements or limitations that are equivalent to those that are recited. Any reference to the “invention” may refer to one or more, but not necessarily all, of the embodiments defined by the claims.

As used herein, “nano-clay additive” is defined as comprising at least one carrier fluid and nano-clay platelets and “nano-clay platelets” are defined as clay particles in which one dimension (the thickness dimension) is not more than 15 nanometers.

As used herein, “aspect ratio” is defined as the length of a platelet filler particle, e.g., mica flake, divided by the width of the platelet.

As used herein, “polymer” may be used to refer to homopolymers, copolymers, interpolymers, terpolymers, etc. Likewise, a “copolymer” may refer to a polymer comprising two monomers or to a polymer comprising three or more monomers.

As used herein, “phr” means parts by weight per hundred parts of a composition on a dry, solids-only basis.

As used herein, “untreated nano-clay platelets” means layered nano-clay platelets that have not been intercalated.

As used herein, “intercalated” means a layered material in which organic molecules have been absorbed between layers of such materials and have complexed with the exchangeable cations on surfaces of such layers.

As used herein, a “treated nano-clay platelet” means layered nano-clay platelets that have been intercalated.

In one or more embodiments, this invention relates to a barrier coating composition for application to a substrate, such as a thermoplastic film, wherein the barrier coating composition improves the barrier properties of the substrate. Optionally, a primer is disposed between the barrier coating and the substrate.

### Barrier Coating Composition

The barrier coating composition according to the present invention comprises a nano-clay additive and a base coating composition. The nano-clay additive comprises nano-clay platelets and at least one carrier fluid. The nano-clay platelets may be treated nano-clay platelets or untreated nano-clay platelets. The base coating composition may be any film base coating that imparts barrier properties to a thermoplastic film.

Preferably, the nano-clay additive may be present in the barrier coating in an amount from about 1 wt % to 50 wt % of the barrier coating.

Nano-clay platelets useful for the current invention include, but are not limited to, hectorite, bentonite, vermiculite, montmorillonite, nontronite, beidellite, volkonskoite, saponite, laponite, sauconite, magaditte, kenyaite, ledikite and mixtures thereof. In a preferred embodiment, the nano-clay platelets are hectorite. Examples of suitable nano-clay platelets are untreated nano-clay platelets, such as BENTONE HC, or treated nano-clay platelets, such as BENTONE ND (both commercially available from Elementis Specialties, Inc. of Hightstown, N.J.).

The nano-clay platelets are present in the nano-clay additive in the amount of less than or equal to about 10 phr; preferably, less than or equal to about 8 phr; more preferably, less than or equal to about 5 phr.

The nano-clay platelets of the nano-clay additive have a thickness ranging from about 1 nanometer to about 15 nanometers. The aspect ratio of the nano-clay platelets ranges from about 50 to about 30,000.

The nano-clay platelets may be dispersed in at least one carrier fluid using any suitable mechanical stirring device. The nano-clay platelets may be dispersed in the carrier fluid in an amount of up to 8 wt %.

Suitable carrier fluids are preferably polar solvents. In some embodiments, the carrier fluid may be water, methanol, ethanol, isopropyl alcohol, methyl ethyl ketone, acetone, tetrahydrofuran, methyl acetate, ethyl acetate and mixtures thereof. The carrier fluid may be present in the barrier coating in an amount ranging from about 1 wt % to 50 wt %.

Suitable base coatings comprise a polymer selected from the group consisting of polyvinylidene chloride (PVdC), poly(vinyl)alcohol (PVOH), ethylene vinyl alcohol (EVOH), and acrylic polymers, and mixtures thereof. Preferably, the base coating comprises from about 50 wt % to 99 wt % of the barrier coating.

Suitable PVdC coatings are any of the known PVdC compositions heretofore employed as coatings in film manufacturing operations, e.g., any of the PVdC materials described in U.S. Pat. No. 4,214,039, U.S. Pat. No. 4,447,494, U.S. Pat. No. 4,961,992, U.S. Pat. No. 5,019,447, and U.S. Pat. No. 5,057,177, all of which are incorporated herein by reference. Preferably, the PVdC coating is Daran 8500 (commercially available from Owensboro Specialty Polymers, LLC of Owensboro, Ky. or Serfene 49×170 from Rohm & Haas of Philadelphia, Pa.).

Suitable vinyl alcohol-based coatings are any of the known PVOH and EVOH compositions used in film manufacturing operations, such as VINOL 125 or VINOL 325 (both commercially available from Air Products, Inc. of Allentown, Pa.). Other PVOH coatings are described in U.S. Pat. No. 5,230,963, incorporated herein by reference. A crosslinker for PVOH is Parez 707, a melamine formaldehyde compound (commercially available from Cytec Industries of West Patterson, N.J.).

Suitable acrylic polymers, include, for example, polymers and copolymers which comprise ethylene acrylic acid (EAA) and one or more of butyl acrylate or ethyl acrylate (collectively referred to as “acrylate copolymers”). Preferably, the acrylic coating is Acrylic 90XWO67 (commercially available from Valspar Corporation of Wheeling, Ill.).

The base coating may be present in the barrier coating in an amount ranging from 50 wt % to about 99 wt %; preferably, from 75 to about 99 wt %; more preferably, from 90 to 99 wt %.

In some embodiments of this invention, the coating may further comprise a wax for lubricity. Any conventional wax, includes, but is not limited to Carnauba™ wax (commercially available from Michelman Inc. of Cincinnati, Ohio), microcrystalline wax, polyethylene wax, and blends thereof are contemplated herein. The wax may be in the form of a dispersion or emulsion, such as Michemlube 215 (commercially available form Michelman Inc. of Cincinnati, Ohio). Wax may be present in the barrier coating in an amount ranging from about 1.0 to 10.0 phr.

The barrier coating of the current invention may further comprise an antiblock agent. Suitable antiblock agents include inorganic particulates selected from the group consisting of silica, silicon dioxide, calcium carbonate, magnesium silicate, talc, aluminum silicate, calcium phosphate, a silicone resin powder, a spherical particle made from methyl methacrylate resin, and mixtures thereof.

One silicone resin powder is a non-meltable, crosslinked silicone resin powder, sold under the trademark “TOSPEARL” and made by Toshiba Silicone Co., Ltd. of Wilton, Conn.; TOSPEARL is described in U.S. Pat. No. 4,769,418. One methyl methacrylate resin is a spherical particle sold under the trademark “EPOSTAR” and commercially available from Nippon Shokubai of Japan. Preferably, the antiblock agent is talc or SYLOBLOC 44 (commercially available from W.R. Grace of Columbia, Md.).

Preferably, talc is Mistron Monomix talc from Luzenac Americas Houston, a division of Rio Tinto Minerals of Denver, Colo. Preferably, silica is Ludox TM-40 from Grace-Davison, a division of W. R. Grace of Columbia, Md.

### Application of Coatings

The barrier coating composition of the present invention may be applied to a substrate using techniques well known to those skilled in the art. Such prior art coating application techniques include, but are not limited to, gravure coating, brush coating, dipping, curtain flow coating, roll coating, or spraying. In the case of single or multiple layer substrates, such as a thermoplastic film, the coating compositions may be applied to at least one outer surface of the substrate. Preferably, the coating compositions may be applied to single layer and multilayer films after they are formed, preferably, after the films have been oriented by stretching in at least one direction. A gravure coating process is the preferred method of applying coatings because it can apply a thin even coating on films. Preferably, the barrier coating of the present invention is applied to a substrate at a coating weight from about 0.01 g/m² to about 4.0 g/m².

Another method for application of the coating compositions of this invention includes a dispersion coating process. In this process, the base film is unwound from a mandrel and the coating applied at the desired thickness. After the coating has dried, the coated film structure is wound up again into a uniform roll.

### Surface Treatment for Substrates

One or both of the outer surfaces of the substrates (e.g., multi-layer films) may be surface-treated to increase the surface energy to render the film receptive to metallization, coatings, printing inks, and/or lamination. The coating may be applied to the film surface after the surface is treated by one or more methods to energize the film surface, such as flame treatment, corona discharge, plasma discharge, UV radiation, electron radiation, chemical treatment and combinations thereof. Alternatively, the coating may be applied to a non-treated film surface that has a surface energy sufficient to promote adhesion of the barrier coating.

### Metallization for Substrates

One or both of the outer surfaces of the substrates (e.g., multi-layer films) may be metallized. Such surfaces may be metallized using conventional methods, such as vacuum metallization by deposition of a metal layer such as aluminum, copper, silver, chromium, or mixtures thereof.

### Substrate Layer

The substrate of the current invention may be any single-layer or multi-layer film commonly known in the art. Preferably, the substrate is selected from the group consisting of glassine, paper, poly-coated paper, oriented or cast thermoplastic films formed from polymers or copolymers of polypropylene, polyethylene, polybutylene, polyethylene terephthalate, polyamide, polystyrene and blends thereof.

### Primer Layer

In applications where even greater adherence of the barrier coating to the substrate is desired, i.e., greater than that resulting from treatment of the film surface by any of the surface treatment methods discussed above, an intermediate primer coating can be optionally employed to increase the adherence of the coating composition to the film. In this case, the film is advantageously first treated by one of the foregoing methods to provide increased active adhesive sites thereon (thereby promoting primer adhesion) and to the thus treated film surface there is subsequently applied a continuous coating of a primer material. Such primer materials are well known in the prior art and include, for example, epoxy and poly(ethylene imine) (PEI) materials. U.S. Pat. Nos. 3,753,769, 4,058,645, 4,439,493, and 5,093,194, all of which are incorporated herein by reference, disclose the use and application of such primers. The primer provides an overall adhesively active surface for thorough and secure bonding with the subsequently applied coating composition and can be applied to the base film by conventional solution coating means, for example, by mating roller application.

It should be evident that this disclosure is by way of example, and that various changes can be made by adding, modifying, or eliminating details without departing from the fair scope of the teaching contained in the disclosure.

### Experimental

The coatings of the present invention will be further described with reference to the following non-limiting examples.

### Testing Methods

Water vapor transmission rate is measured according to ASTM F-1249.

Oxygen transmission rate is measured according to ASTM D-3985.

Surface gloss is measured as % light reflected at about a 45° angle according to ASTM D-2457.

Haze is measured as % light transmitted according to ASTM D-1003.

### EXAMPLES

Two nano-clay additive solutions were prepared. Nano-clay platelet powders, Bentone HC (untreated) and Bentone ND (treated), respectively, were dispersed into water using a lab high speed mechanical stirrer. These powders were slowly added to the water while stirring to prevent the formation of lumps or gels. Total solids content in both solutions was approximately 7%.

The composition of the sample barrier coatings using the nano-clay additive solutions prepared is provided in Table 1, below.

TABLE 1

| | Bentone ® | Bentone ® | Formulated | Formulated | Formulated | |
|---|---|---|---|---|---|---|
| Sample # | HC | ND | acrylics | PVOH | PVdC | |
| 1 | | | 100 | | | control |
| 2 | 2.5 | | 100 | | | |
| 3 | | 2.5 | 100 | | | |
| 4 | | | 100 | | | control |
| 5 | 5.0 | | 100 | | | |
| 6 | | 5.0 | 100 | | | |
| 7 | | | | 100 | | control |
| 8 | 2.5 | | | 100 | | |
| 9 | | 2.5 | | 100 | | |
| 10 | 5.0 | | | 100 | | |
| 11 | | 5.0 | | 100 | | |
| 12 | | | | | 100 | control |
| 13 | 2.5 | | | | 100 | |
| 14 | | 2.5 | | | 100 | |
| 15 | 5.0 | | | | 100 | |
| 16 | | 5.0 | | | 100 | |

For Samples 1-4, the acrylic base coating was made with 100 phr of Acrylic 90XWO67; 35 phr of Ludox TM-40; 0.3 phr of a Mistron Monomix talc; and 6 phr of Michemlube 215 wax emulsion as a slip agent. Bentone HC and Bentone ND were then added in the amounts shown in Table 1 for Samples 1-6 to produce the barrier coating which comprises an acrylic base coating having a coating weight of approximately 0.822 g/msi (grams per thousand square inches).

For Samples 7-11, the PVOH base coating which comprised a 7% polyvinyl alcohol (PVOH) prepared from 100 phr of Elvanol 90-50 (commercially available from DuPont); and 25 phr of Parez, a melamine formaldehyde cross linker. The pH was adjusted to 2.5 using phosphoric acid. Bentone HC and Bentone ND were then added in the amounts shown in Table 1 for Samples 7-11 to produce a barrier coating which comprises a PVOH base coating having a coating weight of approximately 0.503 g/msi.

For Samples 12-16, a polyvinylidene chloride (PVdC) coating was prepared with 100 phr of PVdC (Daran 8500), 0.5 phr of Mistron Monomix talc; and 2 phr of Michemlube 215 wax emulsion as a slip agent. The pH was adjusted to 8.0 using ammonium hydroxide prior to addition of the wax. Bentone HC and Bentone ND were then added in the amounts shown in Table 1 for Samples 12-16 to produce the barrier coating which comprises a PVdC base coating having a coating weight of approximately 3.00 g/msi (grams per thousand square inches).

The films coated with the barrier coatings which contained acrylic base coating, Samples 1-6, were first primed with a standard PEI primer. The PEI primer was applied to the film to yield an optical density of 0.11. The standard PEI primer, comparable to Polymin M, a product of BASF-Wyandotte Corp., had a solids content of 0.07%. The films primed with PEI primer were dried in an oven at a temperature of 220° F. until dry. The line speed for application of the primer was 45 feet per minute (fpm).

The films coated with the barrier coatings which contain PVdC base coating, Samples 12-16, were first primed with a standard epoxy primer. The standard epoxy primer, comparable to the epoxy primer disclosed in Example 5 of U.S. Pat. No. 4,214,039, had a solids content of approximately 22% solids. The epoxy primer was aged for 18 hours and subsequently diluted to 4.5% solids. The epoxy primer was applied to the film at a coating weight of 0.16 g/msi. The films primed with epoxy primer were dried in an oven at a temperature of 240° F. until dry. The line speed for application of the primer was 45 fpm.

Each of the above barrier coatings was then applied on top of the primer a one mil (25 micron) oriented polypropylene base film having an ethylene-propylene copolymer skin using a lab coater. The skin layers of these films were first surface treated with corona treatment on-line under treatment conditions to achieve 40 dynes/cm² on the treated surface prior to application of the primer, referenced above. The films having a barrier coating comprised of an acrylic base coating was dried in an oven at a temperature of 220° F. until dry. The films having an barrier coating comprised of an PVdC or PVOH base coatings were dried in an oven at a temperature of 240° F. until dry. The line speed for application of barrier coatings comprised of acrylic or PVOH base coatings was 45 fpm. The line speed for application of the barrier coating comprised of PVdC base coatings was 35 fpm.

As shown in Table 2, the films having barrier coatings comprised of treated and untreated nano-clay platelets displayed mostly an increase in water vapor transmissions rates (WVTR) for acrylic, PVOH and PVdC base coatings.

The oxygen transmission rates (OTR), however, for the films having barrier coatings comprised of treated and untreated nano-clay platelets displayed differing results depending upon the composition of the base coating. For acrylic barrier coatings comprised of treated and untreated nano-clay platelets present in the amount of 2.5 phr, the OTR increased. The increase in OTR was greater for the barrier coatings comprised of treated nano-clay platelets as compared the coatings comprised of untreated nano-clay platelets. This shows the improvement in OTR properties of the untreated nano-clay platelets as compared to the treated nano-clay platelets.

The acrylic barrier coatings comprised of treated and untreated nano-clay platelets present in the amount of 5.0 phr displayed a decrease in OTR. The decrease in OTR was greater for the barrier coatings comprised of untreated nano-clay platelets as compared to the coatings comprised of treated nano-clay platelets. This shows the surprising improvement in OTR properties of the untreated nano-clay platelets as compared to the treated nano-clay platelets.

The acrylic base coating having treated and untreated nano-clay platelets present in the amount of 2.5 and 5.0 phr had similar surface gloss and haze properties. It was expected that the intercalation of the treated non-clay platelets, would have rendered the platelets more compatible with the polymers of the base coating and produced an improvement in the gloss and haze properties. The result that the lack of treatment of the untreated nano-clay platelets did not have a deleterious effect on gloss or haze properties was surprising.

Also, the films comprised of acrylic base coatings maintained surface gloss and haze properties with good coated appearance.

The PVOH barrier coatings comprised of treated and untreated nano-clay platelets displayed an undesirable substantial increase in the OTR for such films. In one instance, the barrier coating gelled and could not be applied to the film. Also, the coated appearance of films comprised of PVOH base coatings was fair to poor.

The PVdC barrier coatings having nano-clay additives treated and untreated nano-clay platelets displayed a significant improvement in OTR properties where the nano-clay platelets were present in the amount of 2.5 and 5.0 phr. The decrease in OTR was greater for the barrier coatings comprised of untreated nano-clay platelets as compared to the coatings comprised of treated nano-clay platelets. This result was surprising because it was expected that a treated nano-clay platelet would have a greater decrease in OTR than an untreated nano-clay platelet. This is due to fact that the intercalation of the platelets of the treated nano-clay platelet was expected to increase the organophilic tendencies of the platelet, thereby rendering the platelet more compatible with the polymers of the base coating. This result also showed the unexpected improvement in OTR properties of the untreated nano-clay platelets as compared to the treated nano-clay platelets.

The films comprised of PVdC base coatings having nano-clay platelets displayed a reduction in gloss and haze as compared to the PVdC base coatings alone. However, the PVdC base coating having treated and untreated nano-clay platelets present in the amount of 2.5 and 5.0 phr had similar surface gloss and haze properties. It was expected that the intercalation of the treated non-clay platelets, would have rendered the platelet more compatible with the polymers of the base coating and produced an improvement in the gloss and haze properties. The result that the lack of treatment of the untreated nano-clay platelets did not have a deleterious effect on gloss or haze properties was surprising.

TABLE 2

| | | | | | | | WVTR | OTR |
|---|---|---|---|---|---|---|---|---|
| | | | | | | | 100° F. & | 73° F. & |
| | | | Additive | | | | 90% Rel. | 0% Rel. |
| | Base | | Amount | Coated | Surface | % | Hum. | Hum. |
| Sample # | Coating | Additive | phr | Appearance | Gloss | Haze | g/m² | cc/m² |
| 1 | Acrylic | Control | 0 | Good | | | 4.47 | 1250 |
| 2 | Acrylic | Bentone ® HC | 2.5 | Good | | | 4.53 | 1310 |
| 3 | Acrylic | Bentone ® ND | 2.5 | Good | | | 4.37 | 1320 |
| 4 | Acrylic | Control | 0 | | 81.7 | 1.9 | 4.86 | 1322 |
| 5 | Acrylic | Bentone ® HC | 5.0 | | 79.6 | 2.6 | 5.01 | 1282 |
| 6 | Acrylic | Bentone ® ND | 5.0 | | 82.5 | 1.9 | 4.98 | 1287 |
| 7 | PVOH | Control | 0 | Good | | | 4.31 | 1.48 |
| 8 | PVOH | Bentone ® HC | 2.5 | Fair | | | 4.39 | 4.37 |
| 9 | PVOH | Bentone ® ND | 2.5 | Fair | | | 4.30 | 1.63 |
| 10 | PVOH | Bentone ® HC | 5.0 | Poor | | | 4.52 | 12.40 |
| 11 | PVOH | Bentone ® ND | 5.0 | Coating | | | n/a | n/a |
| | | | | gelled | | | | |
| 12 | PVdC | Control | 0 | | 95.6 | 2.0 | 2.53 | 6.83 |
| 13 | PVdC | Bentone ® HC | 2.5 | | 78.3 | 8.2 | 5.36 | 4.35 |
| 14 | PVdC | Bentone ® ND | 2.5 | | 68.7 | 10.2 | 5.17 | 4.75 |
| 15 | PVdC | Bentone ® HC | 5.0 | | 66.6 | 12.1 | 5.25 | 3.39 |
| 16 | PVdC | Bentone ® ND | 5.0 | | 59.1 | 15.4 | 5.31 | 3.76 |

The present invention is described herein with reference to embodiments of a barrier coating. Those skilled in the art will appreciate that numerous modifications to these embodiments may be made without departing from the scope of our invention. To the extent that this description is specific, it is solely for the purpose of illustrating certain embodiments of the invention and should not be taken as limiting the present inventive concepts to these specific embodiments. Therefore, the spirit and scope of the appended claims should not be limited to the description of the embodiments contained herein.

What is claimed is:

1. A barrier coating composition for application to a thermoplastic film comprising:
(a) a nano-clay additive in an amount from about 1 wt % to 50 wt % of said barrier coating, wherein said nano-clay additive comprises untreated nano-clay platelets; and
(b) a base coating in an amount from about 50 wt % to 99 wt % of said barrier coating, wherein said base coating comprises a polymer selected from the group consisting of polyvinylidene chloride (PVdC), poly(vinyl)alcohol (PVOH), ethylene vinyl alcohol (EVOH), acrylate copolymers and mixtures thereof.

2. The barrier coating of claim 1, wherein said nano-clay platelets are selected from the group consisting of hectorite, bentonite, vermiculite, montmorillonite, nontronite, beidellite, volkonskoite, saponite, laponite, sauconite, magaditte, kenyaite, ledikite or mixtures thereof.

3. The barrier coating composition of claim 1, wherein said nano-clay platelets are present in said nano-clay additive in the amount of less than or equal to 10 phr.

4. The barrier coating composition of claim 1, wherein said nano-clay additive further comprises at least one carrier fluid.

5. The barrier coating composition of claim 4, wherein said at least one carrier fluid is a polar solvent selected from the group consisting of water, methanol, ethanol, isopropyl alcohol, methyl ethyl ketone, acetone, tetrahydrofuran, methyl acetate, ethyl acetate and mixtures thereof.

6. The barrier coating composition of claim 1, wherein said polymer of said base coating is comprised of polyvinylidene chloride (PVdC).

7. The barrier coating composition of claim 1, wherein said barrier coating further comprises a wax.

8. The barrier coating composition of claim 7, wherein said wax is selected from the group consisting of carnauba wax, microcrystalline wax, polyethylene wax, and combinations thereof.

9. The barrier coating composition of claim 7, wherein said wax is present in said barrier coating in an amount ranging from about 1.0 to 10.0 phr.

10. The barrier coating composition of claim 1, wherein said barrier coating further comprises an antiblock agent.

11. The barrier coating composition of claim 10, wherein said antiblock agent is selected from the group consisting of silica, silicon dioxide, calcium carbonate, magnesium silicate, talc aluminum silicate, calcium phosphate, a silicone resin powder, a spherical particle made from methyl methacrylate resin, and mixtures thereof.

12. The barrier coating composition of claim 10, wherein said barrier coating is applied to a substrate at a coating weight from about 0.01 g/m² to 4.0 g/m².

13. A barrier film comprising:
(a) a substrate having a first surface and a second surface; and
(b) a barrier coating on at least one of said first surface and said second surface, said barrier coating comprising:
(i) a nano-clay additive in an amount from about 1 wt % to 50 wt % of said barrier coating, wherein the nano-clay additive comprises untreated nano-clay platelets; and
(ii) a base coating in an amount from about 50 wt % to 99 wt % of said barrier coating;
wherein said base coating is comprised of a polymer selected from the group consisting of polyvinylidene chloride (PVdC), poly(vinyl)alcohol (PVOH), ethylene vinyl alcohol (EVOH), acrylate copolymers and mixtures thereof.

14. The barrier film of claim 13, wherein said nano-clay platelet is selected from the group consisting of hectorite, bentonite, vermiculite, montmorillonite, nontronite, beidellite, volkonskoite, saponite, laponite, sauconite, magadiite, kenyaite, ledikite and mixtures thereof.

15. The barrier film of claim 13, wherein said film further comprises a primer layer intermediate said substrate and said barrier coating.

16. The barrier film of claim 15, wherein said primer comprises poly(ethylene imine) or epoxy.

17. The barrier film of claim 13, wherein said substrate comprises a single-layer or multi-layer film.

18. The barrier film of claim 18, wherein said single-layer or multi-layer film is selected from the group consisting of glassine, paper, poly-coated paper, oriented or cast thermoplastic films formed from polymers or copolymers of polypropylene, polyethylene, polybutylene, polyethylene terephthalate, polyamide, polystyrene and blends thereof.

19. The barrier film of claim 13, further comprising a metal layer comprising aluminum, copper, silica, chromium or mixtures thereof.

20. The barrier film of claim 13, wherein said barrier coating layer has a coating weight from about 0.01 g/m² to 4.0 g/m².

21. A method of coating a film substrate, comprising the steps of:
(a) forming a substrate having a first surface and a second surface; and
(b) applying a barrier coating to at least one of said first surface and said second surface, said barrier coating comprising:
(i) a nano-clay additive in an amount from 1 wt % to about 50 wt % of said barrier coating, wherein said nano-clay additive comprises untreated nano-clay platelets; and
(ii) a base coating in an amount from about 50 wt % to 99 wt % of said barrier coating, wherein said base coating comprises a polymer selected from the group consisting of polyvinylidene chloride (PVdC), poly(vinyl)alcohol (PVOH), ethylene vinyl alcohol (EVOH), acrylate copolymers and mixtures thereof.

22. The method of claim 21, further comprising the step of applying a primer intermediate said substrate and said barrier coating prior to application of said barrier coating.

23. The method of claim 22, wherein said primer is poly(ethylene imine) or epoxy.

24. The method of claim 22, wherein said barrier coating and/or said primer are applied to said substrate by at least one of roller coating, spray coating, slot coating, immersion coating, gravure roll coating, reverse direct gravure coating and combinations thereof.

25. A package comprising a barrier film, wherein the barrier film comprises:
(a) a substrate having a first surface and a second surface; and
(b) a barrier coating on at least one of said first surface and said second surface, said barrier coating comprising:
(i) a nano-clay additive in an amount from about 1 wt % to 50 wt % of said barrier coating, wherein said nano-clay additive comprises untreated nano-clay platelets; and
(ii) a base coating in an amount from about 50 wt % to 99 wt % of said barrier coating, wherein said base coating comprises a polymer selected from the group consisting of polyvinylidene chloride (PVdC), poly(vinyl)alcohol (PVOH), ethylene vinyl alcohol (EVOH), acrylate copolymers and mixtures thereof,
said barrier film being formed into a package adapted to contain a product.
